(19) United States
(12) Patent Application Publication
(10) Pub. No.: US 2026/0099424 A1
(43) Pub. Date: Apr. 9, 2026

(54) SYSTEMS AND METHODS FOR MONITORING SYNTHETIC APPLICATION OPERATIONS AND HANDLING APPLICATION OPERATION ERRORS BY RUNBOOKS

(71) Applicant: The PNC Financial Services Group, Inc., Pittsburgh, PA (US)

(72) Inventors: Michael NITSOPOULOS, Pittsburgh, PA (US); Jerold XING, Richmond Hill (CA); Brian WARGO, Washington, PA (US)

(73) Assignee: The PNC Financial Services Group, Inc., Pittsburgh, PA (US)

(21) Appl. No.: 19/374,604

(22) Filed: Oct. 30, 2025

Related U.S. Application Data
(63) Continuation of application No. 19/094,055, filed on Mar. 28, 2025.
(60) Provisional application No. 63/702,853, filed on Oct. 3, 2024.

(51) Int. Cl. G06F 11/3604

(52) U.S. Cl. CPC G06F 11/3612

(57) ABSTRACT

This application is directed to systems and methods for monitoring synthetic application operations and handling application operation errors by runbooks. An exemplary system may include a memory storing instructions and at least one processor configured to execute the instructions to send a permission request message for a synthetic application operation to a permission server; receive a permission acknowledgment message for the synthetic application operation from the permission server, the permission acknowledgment message including a permission for monitoring a plurality of endpoints in an application, wherein the application is configured for performing the application operations; send a monitor request for monitoring the synthetic application operation to an application monitor process after receiving the permission acknowledgment message; send a request for the synthetic application operation to the application; and send a payload of the synthetic application operation to an event monitor process.

### CROSS-REFERENCE TO RELATED APPLICATIONS

The present application claims the benefit of priority to U.S. Provisional Application No. 63/702,853, filed on Oct. 3, 2024, the entire contents of which are incorporated herein by reference.

### TECHNICAL FIELD

The present application relates to synthetic monitoring and runbook automation and, more particularly, to systems and methods for monitoring synthetic application operations and handling application operation errors by runbooks.

### BACKGROUND

When a user accesses a service via an application on a user device or a website to complete a task, the user may encounter an issue on the application or the website and may not be able to complete their task by the service. The user may call the service provider to report the issue or report it through the application or website to the service provider. After receiving the report of the issue, the service provider may have its information technology (IT) team extract an issue code corresponding to the issue and attempt to figure out possible problems causing the issue. The report of the issue may provide only an indication that the issue occurred on the user's account. Such indication of the issue may not provide enough information about the issue for the service provider's IT team to identify possible causes of the issue.

Moreover, many users may report issues on the application or website, the service provider's IT team may be overwhelmed by the issues and may be unable to resolve the issue reported by the user in a timely manner. The user may access a service provided by another provider to complete the task. The occurrence of the issue and/or the user's need to complete the task quickly may cause the user to lose trust in the initial service provider. The initial service provider may thus lose business, and its reputation may suffer.

In addition, between the user reporting the issue and the IT team addressing it, the application or website may have changed relevant data to support other users' operations. Thus, the IT team may not have access to the relevant data at the time the issue occurred on the user's account and may therefore not have enough information to accurately identify the problems causing the issue. Moreover, some services may need to provide protection for user privacy and may not allow intermediate data to be recorded. For example, the user might enter personal identity and confidential information to access the service before the user encounters the issue. The user's personal identity and confidential information may be protected, so it may not be recorded for the IT team to identify the issue. Yet, the personal identity and confidential information may be essential for identifying or diagnosing the issue. In some cases, in order to collect relevant data for resolving the issue, it may be necessary to replicate the issue on the application or website in order to resolve the issue.

Furthermore, in order to provide high-quality services to users, it may be vital for a system to have the capability to identify potential issues that users may encounter and resolve the issues before the users encounter the issues.

Therefore, it may be desirable to have systems and methods for automatically performing and monitoring application operations that replicate and simulate user's operations and handling issues raised by the application operations by an automatic approach before a user encounters any of the issues.

### SUMMARY

Consistent with embodiments of the present disclosure, there is provided a system that may include a memory storing instructions and at least one processor coupled to the memory, the at least one processor may be configured to execute the instructions to send a permission request message for a synthetic application operation to a permission server; receive a permission acknowledgment message for the synthetic application operation from the permission server, the permission acknowledgment message including a permission for monitoring a plurality of endpoints in an application, wherein the application is configured for performing application operations; send a monitor request for monitoring the synthetic application operation to an application monitor process after receiving the permission acknowledgment message; send a request for the synthetic application operation to the application; and send a payload of the synthetic application operation to an event monitor process.

Also, consistent with embodiments of the present disclosure, there is provided a system that may include a memory storing instructions and at least one processor coupled to the memory, the at least one processor may be configured to execute the instructions to receive an error event message from an application monitor process, the error event message including information about an error in a synthetic application operation on an application, wherein the application is configured for performing application operations; receive a payload of the synthetic application operation from a synthetic monitor process; send a log event message to an event handling process, the log event message including the information about the error event message; and send a payload event message to the event handling process, the payload event message including the payload of the synthetic application operation.

In addition, consistent with embodiments of the present disclosure, there is provided a system that may include a memory storing instructions and at least one processor coupled to the memory, the at least one processor may be configured to execute the instructions to receive a log event message from an event monitor process, the log event message including information about an error in a synthetic application operation on an application, where the application is configured for performing the application operations; select one of a plurality of runbooks based on the information about the error in the synthetic application operation, where the one of the plurality of runbooks includes one or more steps for handling the error in the synthetic application operation; and run the one of the plurality of runbooks to fix an issue causing the error in the synthetic application operation.

Furthermore, embodiments of the present disclosure may also include computer systems, apparatuses, processes, and computer programs recorded on one or more computer storage devices, each configured to perform the actions disclosed in the present disclosure.

It is to be understood that the foregoing general description and the following detailed description are exemplary and explanatory only and are not restrictive of the disclosed embodiments.

### BRIEF DESCRIPTION OF THE DRAWINGS

The accompanying drawings, which are incorporated in and constitute a part of this specification, illustrate disclosed embodiments and, together with the description, serve to explain the disclosed embodiments.

FIG. 1A illustrates an exemplary scenario when a user encounters an error on a service system.

FIG. 1B illustrates an exemplary solution for automatically performing and monitoring application operations that replicate and simulate the user's operation and handling the error by an automatic approach, according to some embodiments of the present disclosure.

FIG. 1C illustrates the exemplary scenario in FIG. 1A with details of the service system when the user encounters the error on the service system.

FIG. 1D illustrates the exemplary solution in FIG. 1B with details of the service system for automatically performing and monitoring application operations that replicate and simulate the user's operation and handling the error by an automatic approach, according to some embodiments of the present disclosure.

FIG. 2A illustrates an exemplary service system and a service resilience system, according to some embodiments of the present disclosure.

FIG. 2B is a block diagram of the exemplary service system of FIG. 2A, according to some embodiments of the present disclosure.

FIG. 2C is a block diagram of the exemplary service resilience system in FIG. 2A, according to some embodiments of the present disclosure.

FIG. 3 is a functional diagram of an exemplary service resilience system, according to some embodiments of the present disclosure.

FIG. 4 is a functional diagram of an exemplary synthetic monitor portal, according to some embodiments of the present disclosure.

FIG. 5 is a flow chart of an exemplary process for monitoring application operations, according to some embodiments of the present disclosure.

FIG. 6 is a flow chart of an exemplary process for monitoring error events, according to some embodiments of the present disclosure.

FIG. 7 is a flow chart of an exemplary process for handling an event in application operations, according to some embodiments of the present disclosure.

### DETAILED DESCRIPTION

Reference will now be made in detail to exemplary embodiments, discussed with regard to the accompanying drawings. In some instances, the same reference numbers will be used throughout the drawings and the following description to refer to the same or like parts. Unless otherwise stated, technical and/or scientific terms have the meaning commonly understood by one of ordinary skill in the art. It is to be understood that other embodiments may be utilized and that changes may be made without departing from the scope of the disclosed embodiments. For example, unless otherwise indicated, method steps disclosed in the figures may be rearranged, combined, or divided without departing from the envisioned embodiments. Similarly, additional steps may be added, or steps may be removed without departing from the envisioned embodiments. Thus, the materials, methods, and examples are illustrative only and are not intended to be necessarily limited.

A user may access a service via an application or a webpage on a user device. The user may initiate a transaction for the service on the application or webpage but encounter an issue and may not be able to complete the transaction. Such an issue may need to be handled and resolved.

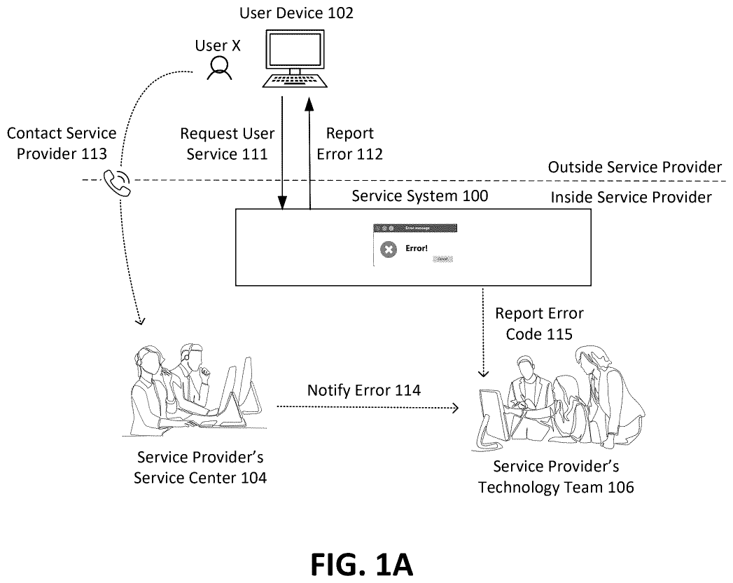

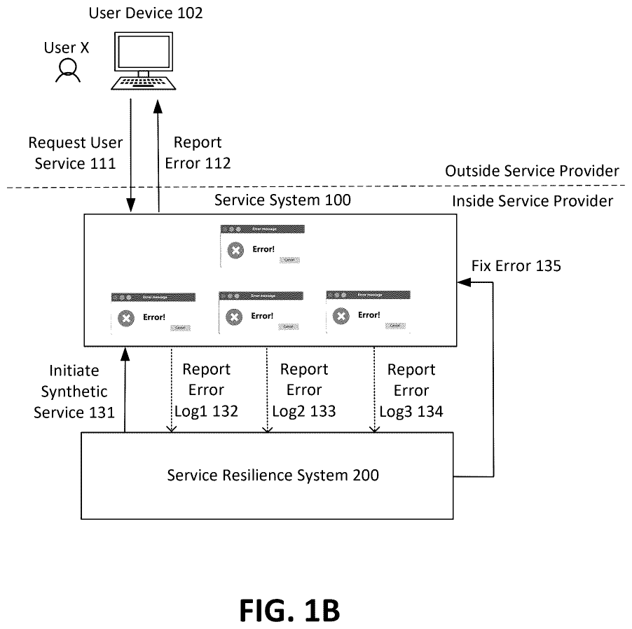

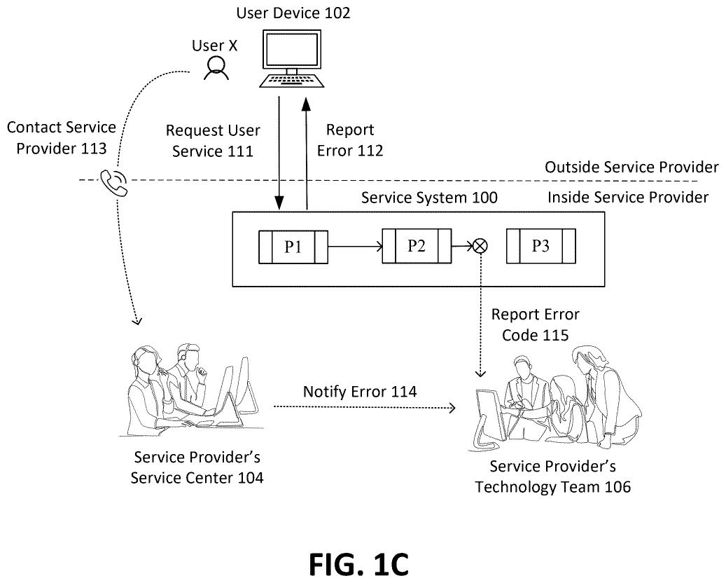

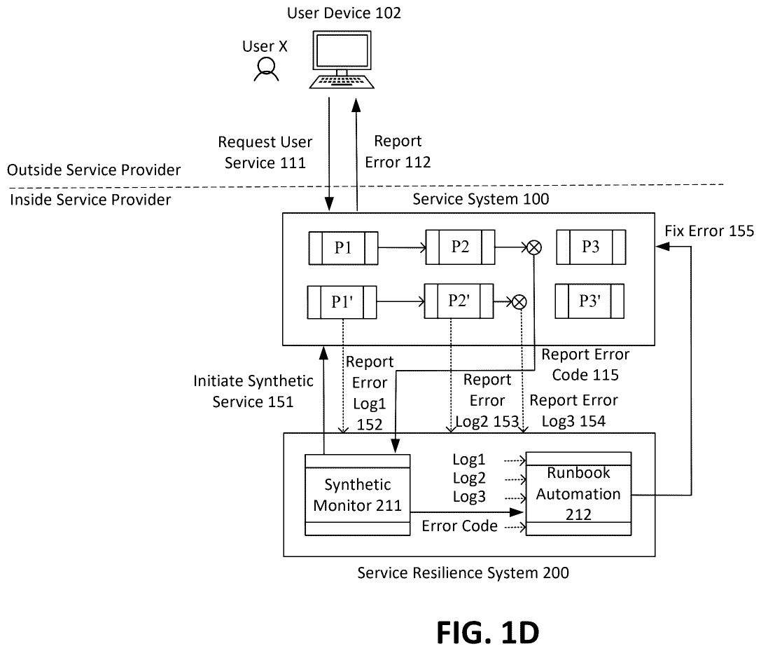

FIG. 1A illustrates an exemplary scenario when a user encounters an error on a service system. As shown in FIG. 1A, a user X may access a service via an application or a webpage on a user device 102, such as a computer or a smartphone. User X may request a user service on a service system 100 of the service provider (operation 111 in FIG. 1A). The user service may be provided by a service provider via the application or the webpage to customers. The service provider may be a government agent, an academic institute, a financial institution, a bank, a retailer, a supermarket, and a client consultant. Because user X may be a customer, user X may be considered outside the service provider, as shown in FIG. 1A. On the other side, a service provider may establish service system 100 and have a service center 104 to handle user X's report of the error and a technology team 106 to analyze and resolve the error. Service system 100 and the service provider's service center 104 and technology team 106 are considered inside the service provider. Service system 100 may operate procedures in order to provide the user service to user X but encounter an error. Service system 100 may then generate an error code and report the error by sending an error message to display on the application or webpage on user device 102 of user X (operation 112 in FIG. 1A).

After user X sees the error message on the application or webpage, user X may contact the service provider to report the error, such as by calling the service provider's service center 104 to complain about the failure of the requested user service and report the error (operation 113 in FIG. 1A). Other reporting mechanisms include use of a chat window, text, email, etc. The service provider's service center 104 may notify technology team 106 of the error by sending an error report to the service provider's technology team 106 and request a resolution (operation 114 in FIG. 1A). After receiving the error report and/or the request for the resolution, the service provider's technology team 106 may retrieve the error code from service system 100 based on the error report (operation 115 in FIG. 1A).

The service provider's technology team 106 may then identify potential issues causing the error based on the error code, and if available, information provided by user X and forwarded by service center 104. If the service provider's technology team 106 identifies one or more potential issues, technology team 106 may make temporary changes to service system 100 and perform tests. In some scenarios, the service provider's technology team 106 may contact user X to resolve the error and assist user X to access the user service.

The error resolution procedure described above may have several potential problems. For example, the error code received by technology team 106 may provide only limited information for identifying the potential issues causing the error. Even with the information provided by user X, technology team 106 may not be able to identify a real issue that cased the error encountered by user X. In this situation, the changes to service system 100 made by technology team 106 may not resolve the real issue in service system 100. In some situations, many users may encounter and report errors to the service provider's service center 104. The service provider's technology team 106 may be overwhelmed by the error reports and not be able to contact each of the users to resolve the encountered error and assist them in accessing the user service. Those users who do not receive assistances may use services provided by another service provider, which may have a business and reputational impact on the service provider.

In addition, between the time user X reports the error and when the service provider's technology team 106 addresses it, service system 100 may have changed relevant data to support other users'services. The service provider's technology team 106 may not have a chance to access to the relevant data at the time the error occurred in the user service for user X and may not have enough information to accurately identify the issue that caused the error. Moreover, the user service may need to provide protection for user X's privacy and may not allow intermediate data with user X's private and/or confidential information to be recorded. As an example, user X may enter personal identity and confidential information to access the user service. User X's personal identity and confidential information may be protected and may not be recorded. As a result, the service provider's technology team 106 may not have error-related information to develop a solution and/or fix the error in service system 100.

FIG. 1B illustrates an exemplary solution for automatically performing and monitoring application operations that replicate and simulate the user's operation and handling the error by an automatic approach, according to some embodiments of the present disclosure. As shown in FIG. 1B, user X may request a user service on a service system 100 of the service provider (operation 111 in FIG. 1B). Service system 100 may operate procedures to provide the user service to user X but encounter an error. Service system 100 may then generate an error code and send an error message to display on the application or webpage on user device 102 of user X (operation 112 in FIG. 1B). As shown in FIG. 1B, a service resilience system 200 may be connected to service system 100 and may be configured to request service system 100 to perform one or more synthetic services that may result in the same types of errors that user X may encounter. For example, service resilience system 200 may be configured to initiate a synthetic service on service system 100 (operation 131 in FIG. 1B). The one or more synthetic services may be created, by technology team 106, as the same user service as user X requested, except that the one or more synthetic services may be the service provider's simulated user services, not the user service requested by user X or user services requested by other customers of the service provider.

Because the one or more synthetic services belong to the service provider and do not belong to customers, service system 100 may record relevant data when the one or more synthetic services encounter errors. In addition to the error code, the relevant data at the time the errors occur may provide information that assists technology team 106 in identifying which one of the potential issues causes the errors. For example, as show in FIG. 1B, service resilience system 200 may be configured to receive reports of Error Log1, Error Log2, and Error Log3 from service system 100 that include relevant data when the one or more synthetic services encounter the errors (operations 132, 133, and 134 in FIG. 1B). Service resilience system 200 may be configured to identify one of the potential issues causing the error that user X encounters based on Error Log1, Error Log2, and Error Log3. As a result, service resilience system 200 may identify the issue causing an error among the potential issues, without a contact with user X and/or information provided by user X. Service resilience system 200 may be further configured to fix the error in service system 100 by a change corresponding to the identified issue (operation 135 in FIG. 1B).

As described above, by the one or more synthetic services, service resilience system 200 may be able to accurately identify an issue that causes the error encountered by user X. Moreover, service resilience system 200 may be able to resolve errors even before a user reports them, if service resilience system 200 is configured to perform a plurality of synthetic services for a variety of potential issues. Furthermore, because the one or more synthetic services do not belong to customers, there may be no concerns about user privacy. The relevant data to be recorded may include more necessary information for accurately identifying the issue. Any of these advantages provided by service resilience system 200 may strengthen service quality of service system 100 and create a better user experience. The service provider's technology team 106 may need to handle a fewer number of errors because at least some potential issues may be identified by service resilience system 200 using the one or more synthetic services. In addition, because Error Log1, Error Log2, and Error Log3 may include more relevant information when errors occur, technology team 106 may also have the more relevant information to analyze and identify the errors. This may result in a higher successful rate for resolving the errors.

FIG. 1C illustrates the exemplary scenario in FIG. 1A with details of the service system when the user encounters the error on the service system. As shown in FIG. 1C, user X may access a service via an application or a webpage on user device 102, such as a computer or a smartphone. For example, user X may request a service, such as a transaction service, that requires a service system 100 of the service provider to perform procedures P1, P2, and P3 in sequence (operation 111 in FIG. 1C). The service may be provided by a service provider via the application or the webpage to customers. Because user X may be a customer, user X may be considered outside the service provider, as shown in FIG. 1C. Inside the service provider, a service provider may establish service system 100 and have service center 104 to handle user X's report for the error and technology team 106 to analyze and resolve the error. Service system 100 and the service provider's service center 104 and technology team 106 are considered inside the service provider.

Service system 100 may perform procedure P1 successfully but encounter an issue in procedure P2 and not be able to complete procedure P2, as shown in FIG. 1C. Service system 100 may then terminate at procedure P2 and generate an error code. Service system 100 may also report the error by sending an error message to display on the application or webpage on user device 102 (operation 112 in FIG. 1C). Service system 100 could be operated by an entity such as a government agent, an academic institute, a financial institution, a bank, a retailer, a supermarket, and a client consultant.

After user X sees the error message on the application or webpage, user X may contact the service provider's service center 104 to complain about the failure of the transaction and report the error (operation 113 in FIG. 1C). The service provider's service center 104 may notify technology team 106 of the error by sending an error report and request a resolution (operation 114 in FIG. 1C). After receiving the error report and/or the request for the resolution, the service provider's technology team 106 may request a report of the error code from service system 100 and attempt to identify potential issues causing the error (operation 115 in FIG. 1C). If the service provider's technology team 106 identifies one or more potential issues, the technology team 106 may make temporary changes to service system 100. The service provider's technology team 106may execute tests by itself and may contact user X to try the transaction again. If there is a need, the service provider's technology team 106 may interact with user X to resolve the error and assist user X to complete the transaction.

The error resolution procedure described above may help user X complete the transaction if user X has time to contact the service provider's service center 104 and work with the service provider's technology team 106. Nonetheless, several potential problems may arise in the use of the service provider's services via the application or webpage on user device 102. For example, the termination of the transaction may cause frustration and inconvenience for user X, who may have to initiate the transaction again or seek alternative means to complete the transaction. Moreover, the process of reporting the error and requesting a resolution may involve multiple parties, including the service provider's service center 104 and technology team 106. This may result in delays and miscommunication, which may further frustrate user X and impact the service provider's reputation. In addition, the error code retrieved by the technology team 106 may not provide sufficient information to accurately identify an issue that causes the error. This may lead to confusion and further delay in completing the transaction. Furthermore, some services may need to provide protection for user privacy and may not allow service system 100 to record intermediate data for people other than user X. As a result, the service provider's technology team 106 may not have error-related information to develop a solution and/or fix the issue in service system 100.

FIG. 1D illustrates the exemplary solution in FIG. 1B with details of the service system for automatically performing and monitoring application operations that replicate and simulate the user's operation and handling the error by an automatic approach, according to some embodiments of the present disclosure. As shown in FIG. 1D, user X may request a user service, such as a transaction, that requires service system 100 to perform procedures P1, P2, and P3 in sequence (operation 111 in FIG. 1D), as described above with reference to FIG. 1C. Service system 100 may successfully perform procedure P1 but encounter an issue in procedure P2. Service system 100 may then terminate at procedure P2 and generate an error code. Service system 100 may be configured to report the error to user device 102 (operation 112 in FIG. 1D)

Service resilience system 200 (as shown in FIG. 1D) may be configured to obtain a report of the error code from service system 100 (operation 115 in FIG. 1D). A synthetic monitor 211 of service resilience system 200 may be configured to generate a synthetic transaction based on the error code. Synthetic monitor 211 may be a process configured to generate a synthetic service that may encounter the error. In some embodiments, synthetic monitor 211 may be the synthetic service that may be sent to execute on an application or website in order to trigger the error and monitor relevant data when the error occurs. The synthetic transaction may be one kind of synthetic monitors configured to transfer an amount of money from a source account to a destination account. For example, service resilience system 200 may be configured to initiate an synthetic service, such as the synthetic transaction, on service system 100 (operation 151 in FIG. 1D).

The synthetic transaction may require service system 100 to perform procedures P1′, P2′, and P3′ in sequence, which are the same procedures as procedures P1, P2, and P3 of user X's transaction. Because there may be no privacy issues for the synthetic transaction, synthetic monitor 211 may be configured to obtain authorization for monitoring executions of procedures P1′, P2′, and P3′ of the synthetic transaction in service system 100. Service resilience system 200 could be operated by an entity such as a government agent, an academic institute, a financial institution, a bank, a retailer, a supermarket, and a client consultant.

Because the synthetic transaction is authorized to be monitored, service system 100 may be configured to record processed data of procedures P1′ and P2′ before the termination of the transaction and save as Log1 and Log2 data in service system 100. Service system 100 may also be configured to save an Log3 data when it encounters the issue in procedure P2′ and terminates the synthetic transaction. The Log3 data may include a same error code as that of user X's transaction. Additionally or alternatively, in some embodiments, the Log3 data may include a plurality of processing data stored in one or more memories of service system 100 when service system 100 encounters the issue.

As shown in FIG. 1D, service resilience system 200 may be configured to obtain reports of the Log1, Log2, and Log3 data from service system 100 (operations 152, 153, and 154 in FIG. 1D). A runbook automation process 212 of service resilience system 200 may be configured to analyze the Log1, Log2, and Log3 data, and the error code to select one of a plurality of runbooks for fixing the issue. Additionally or alternatively, in some embodiments, synthetic monitor 211 may be configured to send a payload of the synthetic transaction to runbook automation process 212. Runbook automation process 212 may be configured to select the one of a plurality of runbooks based on the Log1, Log2, and Log3 data, the error code, and/or the payload of the synthetic transaction. Runbook automation process 212 may also be configured to perform the selected one of the plurality of runbooks to fix the error in service system 100 (operation 155 in FIG. 1D).

In this manner, service resilience system 200 may have more relevant data about the issue causing the termination of the synthetic transaction. For example, the Log1, Log2, and Log3 data, the error code, and/or the payload of the synthetic transaction may provide processing data and parameters of service system 100 when the error occurs for service resilience system 200 to identify a correct issue causing the termination and enable service resilience system 200 to select a correct one among the plurality of runbooks to resolve the issue. By using the synthetic transaction and service resilience system 200, the service provider may not need to occupy user X's time to resolve the issue. The service provider's service center 104 and technology team 106 may not need to spend time on such an issue that service resilience system 200 may be able to resolve by using the synthetic transaction.

In some embodiments, synthetic monitor 211 may be configured to initiate a plurality of synthetic transactions to automatically identify and resolve potential issues in service system 100 by the plurality of runbooks. Each runbook may include one or more detailed step-by-step instructions for completing one or more tasks. Service resilience system 200 may be configured to perform the instructions of a runbook to fix an issue in service system 100, where the issue is encountered when service provider 100 performs one of the plurality of synthetic transactions. In some embodiments, the instructions of the runbook may be used to set up or reset service system 100 to resume providing user services after responding to incidents and alerts.

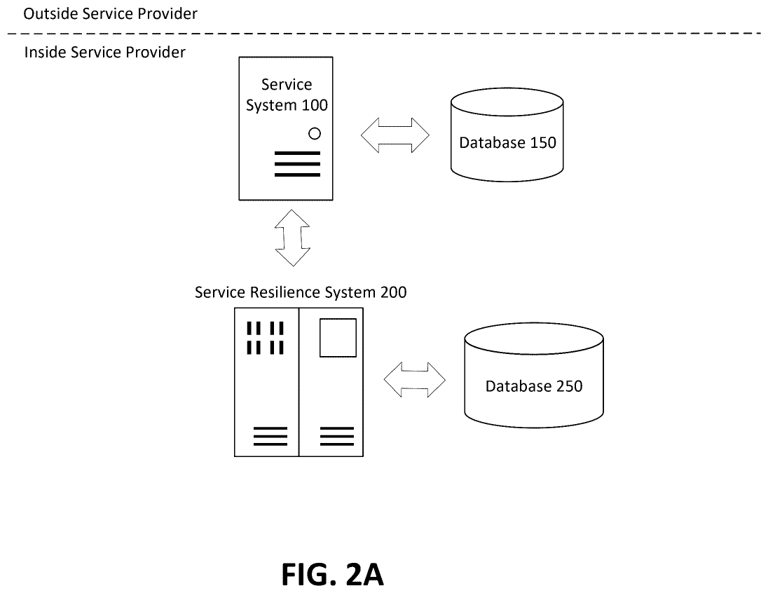

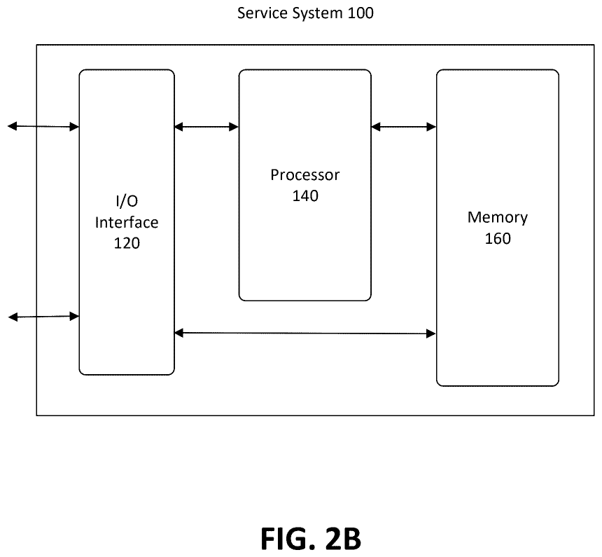

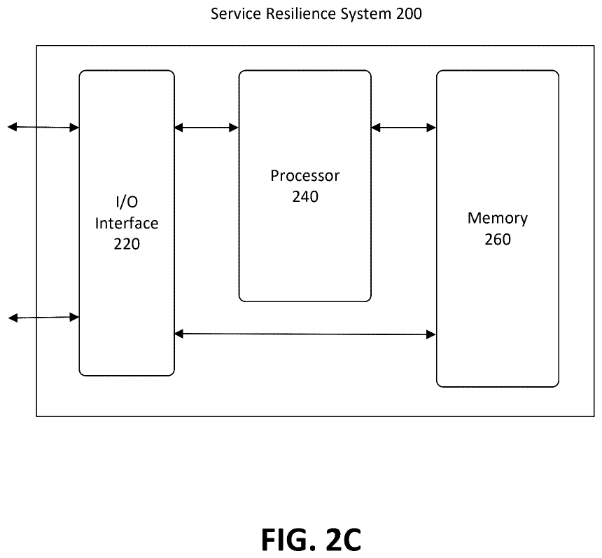

FIG. 2A illustrates exemplary service system 100 and service resilience system 200, according to some embodiments of the present disclosure. As shown in FIG. 2A, service system 100 may connect to a database 150. Database 150 may be configured to store information about users, such as user accounts and subscribed services. Service system 100 may be configured to provide a plurality of transactions and services to users. The plurality of transactions and services may include, for example, bill, online, and loan payments, wire transfers, account or virtual account summaries, internal or external transfers, transaction histories, account preferences, the ability to view cards, the ability to lock and unlock cards, travel notices, the ability to report cards lost and/or stolen, close accounts, and/or rewards. Service system 100 may also be configured to provide other transactions and services to users. Service system 100 may be operatively connected with service resilience system 200. When service system 100 is configured to perform synthetic transactions, service system 100 may be configured to record processed data of procedures included in synthetic transactions and save the processed data of procedures as a plurality of log data. Service resilience system 200 may be configured to request service system 100 to provide the plurality of log data.

Service resilience system 200 may be a computer with one or more memories and one or more data processors for monitoring synthetic transactions and service operations and handling issues by runbooks. As shown in FIG. 2A, service resilience system 200 may be connected to a database 250 to access a plurality of data that may be required for analyzing the plurality of log data from service resilience system 200 and selecting one of a plurality of runbooks to handle the issues. Database 250 may be configured to store the plurality of runbooks and a look-up table to map a plurality of error codes and other parameters to one of the plurality of runbooks.

FIG. 2B is a block diagram of exemplary service system 100 of FIG. 2A, according to some embodiments of the present disclosure. As shown in FIG. 2B, service system 100 may include an input/output (I/O) interface 120, a processor 140, and a memory 160. Processor 140 may be coupled to I/O interface 120 to input and/or output data from/to external components, such as database 150 (as shown in FIG. 2A) and service resilience system 200 (as shown in FIG. 2A). Processor 140 may also be coupled to memory 160 to access data for providing services. These elements of service system 100 may be configured to transfer data and send or receive instructions and signals between or among each other.

I/O interface 120 may be coupled with processor 140 to receive input data and/or message from and output data and messages to database 150 and/or service resilience system 200, such as service accounts and agreements, permissions for transaction and authorization, and user information. The service accounts and agreements may include account numbers, user identities, and account agreements. The permissions for transaction and authorization may include information about which transaction functions are available and/or authorized. The user information may include usernames and passwords associated with the user identities. In some embodiments, I/O interface 120 may include one or more wireline and/or wireless network interfaces, such as wireless local area network (WLAN) and/or Wi-Fi network interfaces. Service system 100 may be configured to transmit and/or receive data with database 150 and/or service resilience system 200 via the one or more WLAN and/or Wi-Fi network interfaces.

Processor 140 may include any appropriate type of one or more general-purpose or special-purpose microprocessors, digital signal processors, artificial intelligence processors, and/or microcontrollers. Processor 140 may be configured by one or more programs stored in memory 160 to perform operations with respect to the systems, devices, and methods illustrated and described herein.

Memory 160 may include any appropriate type of mass storage provided to store any type of information that processor 140 may need to operate. Memory 160 may include one or more of a volatile or non-volatile, magnetic, semiconductor, tape, optical, removable, non-removable, or other type of storage device or tangible (i.e., non-transitory) computer-readable medium including, but not limited to, a read-only memory (ROM), a flash memory, a dynamic random-access memory (RAM), and a static RAM. Memory 160 may be configured to store one or more programs for execution by processor 140 for providing services, as disclosed herein. Memory 160 may be further configured to store information and data received from database 150 and service resilience system 200 for monitoring synthetic transactions.

FIG. 2C is a block diagram of exemplary service resilience system 200 in FIG. 2A, according to some embodiments of the present disclosure. As shown in FIG. 2C, service resilience system 200 includes an input/output (I/O) interface 220, a processor 240, and a memory 260. Processor 240 may be coupled to I/O interface 220 to input and/or output data from/to external components, such as database 250 (as shown in FIG. 2A) and service system 100 (as shown in FIG. 2A). Processor 240 may also be coupled to memory 260 to access data for monitoring synthetic transactions and handling errors by runbooks. These elements of service resilience system 200 may be configured to transfer data and send or receive instructions and signals between or among each other.

I/O interface 220 may be coupled with processor 240 to receive input data and/or messages from and output data and messages to database 150 and/or service resilience system 200, such as the Log1, Log2, and Log3 data and outgoing messages to fix issues in service system 100. The Log1, Log2, and Log3 data may include processed data during procedures P1′, P2′, and/or P3′ and the termination of synthetic transactions. The outgoing messages may include authentication requests, initiation requests for synthetic transactions, and change requests for fixing issues. In some embodiments, I/O interface 220 may include one or more wireline and/or wireless network interfaces, such as WLAN and/or Wi-Fi network interfaces. Service resilience system 200 may be configured to transmit and/or receive data and messages with database 250 and/or service system 100 via the one or more WLAN and/or Wi-Fi network interfaces.

Processor 240 may include any appropriate type of one or more general-purpose or special-purpose microprocessors, digital signal processors, artificial intelligence processors, and/or microcontrollers. Processor 240 may be configured by one or more programs stored in memory 260 to perform operations with respect to the systems, devices, and methods illustrated and described herein.

Memory 260 may include any appropriate type of mass storage provided to store any type of information that processor 240 may need to operate. Memory 260 may include one or more of a volatile or non-volatile, magnetic, semiconductor, tape, optical, removable, non-removable, or other type of storage device or tangible (i.e., non-transitory) computer-readable medium including, but not limited to, a read-only memory (ROM), a flash memory, a dynamic random-access memory (RAM), and a static RAM. Memory 260 may be configured to store one or more programs for execution by processor 240 for monitoring synthetic transactions and handling errors by runbooks, as disclosed herein. Memory 260 may be further configured to store information and data received from database 250 and service system 100 for monitoring synthetic transactions and handling errors by runbooks.

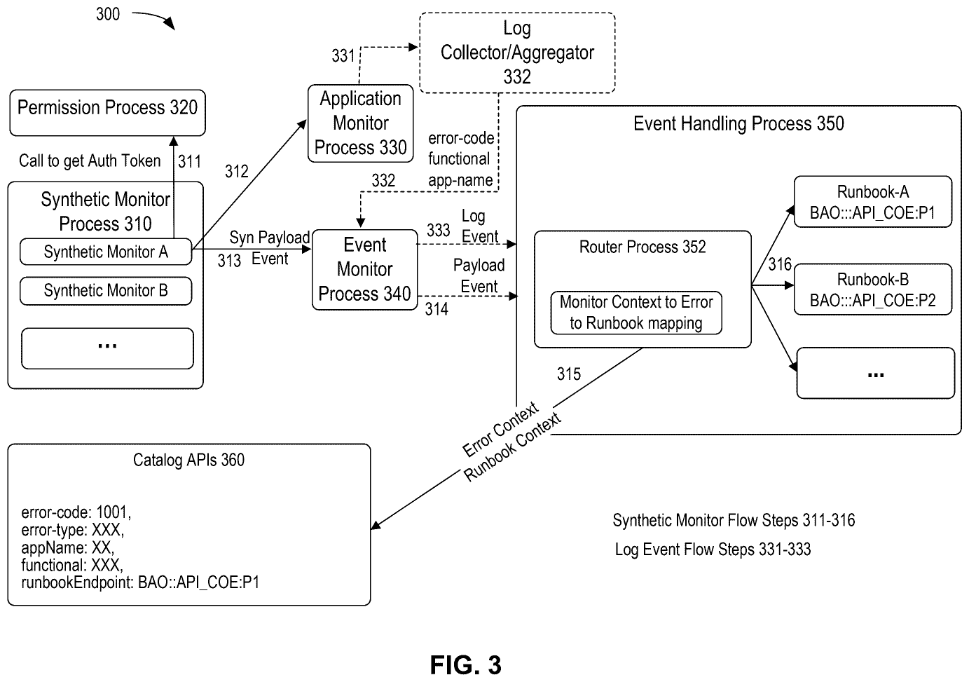

FIG. 3 is a functional diagram of an exemplary service resilience system 300, according to some embodiments of the present disclosure. Service resilience system 300 may be implemented by service resilience system 200 and its components as described above with reference to FIG. 2C. For example, processor 240 may be configured to perform instructions stored in memory 260 to perform operations as described below with reference to FIGS. 3-7. In some embodiments, service resilience system 300 may be implemented one or more computers to perform operations as described below with reference to FIGS. 3-7.

As shown in FIG. 3, service resilience system 300 may be configured to perform a synthetic monitor process 310, a permission process 320, an application monitor process 330, an event monitor process 340, and/or an event handling process 350. In some embodiments, service resilience system 300 may include a plurality of computers configured to perform one or more of the processes described herein. In some embodiments, permission process 320, application monitor process 330, and/or event monitor process 340 may be performed by one or more computer systems other than service resilience system 300. Service resilience system 300 may be configured to communicate with the one or more computer systems through wireline or wireless connections.

In FIG. 3, synthetic monitor flow steps 311-316 illustrate an exemplary monitor flow in sequence as to how to monitor a synthetic monitor (e.g., a synthetic service) executed in service system 100 (FIGS. 1B, 1D, 2A). In some embodiments, one or more of synthetic monitor flow steps 311-316 may occur in a varied sequence or in parallel. Log event flow steps 331-333 illustrate an exemplary log event flow as to how to record an event occurring during the execution of the synthetic monitor. In some embodiments, one or more of log even flow steps A-C may occur in a varied sequence or in parallel.

Synthetic monitor process 310 may include a synthetic monitor A and a synthetic monitor B. Each of synthetic monitors A and B may be a synthetic service by which the service provider simulates a user service and allows the synthetic service to be monitored during processing. A synthetic monitor (i.e., a synthetic service) may have exactly the same contents as a user service requested by a user, except that the synthetic monitor may be allowed to be monitored. For example, when synthetic monitor A is executed in service system 100, all data and changes related to synthetic monitor A may be recorded as log files for analysis.

Permission process 320 may be an authentication administration process configured to verify whether a service request is from a valid user or system administer and authorize a permission when the service request is valid. Permission process 320 may be configured to authorize a service request with a permission to execute, a permission to be monitored, and/or a permission to access data.

As shown in FIG. 3, synthetic monitor A may be configured to send permission process 320 a request for authorization to run and monitor a synthetic transaction (synthetic monitor flow step 311 in FIG. 3). The request for authorization may be, for example, a call to get an authorization token. Synthetic monitor A may include a valid system administrator's identifier. Therefore, permission process 320 may be configured to verify the request for authentication is valid and send an authentication approval. Synthetic monitor A may also be configured to receive the authorization approval from permission process 320. The authorization approval may include, for example, an authorization token for monitoring one or more endpoints when the synthetic transaction is performed. The authentication token may include an identifier indicating a process containing the token is authorized. In some embodiments, the authorization token may be used to verify the authentication status.

Synthetic monitor A may be further configured to send a monitor request to application monitor process 330 to ask for monitoring the execution of the synthetic transaction (synthetic monitor flow step 312 in FIG. 3). The monitor request may include the authorization token. In addition, synthetic monitor A may be configured to send a request (not shown in FIG. 3) for the synthetic transaction to an application or website of service system 100 (FIG. 1D). Upon receiving the request, service system 100 may be configured to perform the synthetic transaction. The synthetic transaction may include transaction information and a payload. The transaction information may indicate a transaction type. The payload may include relevant data for the transaction. In some embodiments, synthetic monitor A may also be configured to send the payload of the synthetic transaction to event monitor process 340 (synthetic monitor flow step 313 in FIG. 3). Event monitor process 340 may be a process configured to monitor events that occur when synthetic monitor A or B is executed in service system 100 (FIGS. 1B, 1D, 2A).

Permission process 320 may be configured to receive a request for authorization to run and monitor a synthetic transaction from synthetic monitor process 310, such as synthetic monitor A therein. The request for authorization may be, for example, the call to get an authorization token for the synthetic transaction. Permission process 320 may be configured to check and determine that the transaction in the request for authorization is a synthetic one, which may not have user privacy issues, and approve the request with an authorization token for monitoring the synthetic transaction. Permission process 320 may be further configured to send the authorization approval to synthetic monitor process 310.

Application monitor process 330 may be configured to monitor an execution status of the synthetic transaction on the application or website. For example, application monitor process 330 may also be configured to monitor execution times of operations on the application or website. In some embodiments, if an execution time of one of the operations is longer than a threshold, application monitor process 330 may be configured to collect log data during the execution of the one of the operations. In some embodiments, application monitor process 330 may also be configured to collect log data during the execution of the synthetic transaction. The log data may include a part or all of data processed during the execution of the synthetic transaction. Application monitor process 330 may be configured to run a log collector or aggregator 332 to collect the log data during the execution of the synthetic transaction (log event flow step 331 in FIG. 3). Log collector or aggregator 332 may be a program performed on the same computer as application monitor process 330 or on a computer different from that performs application monitor process 330.

When an error occurs during the execution of the synthetic transaction, log collector or aggregator 332 may be configured to collect an error code generated from the application or website executing the synthetic transaction. Log collector or aggregator 332 may also be configured to generate functional information used to help event handling process 350 handle the error. The functional information may include, for example, a few keywords corresponding to a step at which the error occurs or an issue that causes the error. The functional information may correspond to one or more support teams that may be relevant to the error. In some embodiments, the functional information may be sent to the one or more corresponding support teams. Log collector or aggregator 332 may also be configured to include the error code, the functional information, and the application or website name in an error event message and send the error event message to event monitor process 340 (log event flow step 332 in FIG. 3).

Event monitor process 340 may be configured to receive the error event message from log collector or aggregator 332. As described above for application monitor process 330, the error event message may include the error code, the functional information, and the application or website name. Event monitor process 340 may also be configured to generate a log event message based on the error event message and send the log event message to event handling process 350 (log event flow step332 in FIG. 3). The log event message may include the error code, the functional information, the application or website name, and temporary data during the execution of synthetic monitor A or B. In some embodiments, event monitor process 340 may also be configured to receive the payload of the synthetic transaction from synthetic monitor process 310. For example, event monitor process 340 may also be configured to generate an event payload message based on the payload of the synthetic transaction and send the payload event message to event handling process 350 (synthetic monitor flow step 314 in FIG. 3). In some embodiments, event monitor process 340 may be configured to include contents of the error event message and the payload of the synthetic transaction in an event message and send the event message to event handling process 350 (a combination of log event flow step 333 and synthetic monitor flow step 314 in FIG. 3).

Event handling process 350 may be a process configured to handle events during the execution of synthetic monitor A or B. Event handling process 350 may be configured to receive the log event message from event monitor process 340. The log event message may include the error code, functional information, and/or the application name. Event handling process 350 may also be configured to receive the payload event message from event monitor process 340. For example, when synthetic monitor A is a wire transfer of an amount of money from a source account to a destination account, the payload event message may include the source account, the destination account, the amount of money, and a transaction method (i.e., the wire transfer).

As shown in FIG. 3, event handling process 350 may include a router process 352, a runbook A, a runbook B, and one or more other runbooks. Router process 352 may be configured to look up, for example, a catalog application programming interfaces (APIs) 360 based on the log event message to select one of the runbooks for handling the error (synthetic monitor flow step 315 in FIG. 3). Specifically, router process 352 may be configured to compare, for example, the error code, the functional information, and/or the application or website name included in the log event message with entries of catalog APIs 360 and select one of the entries having the same error code, the functional information, and/or the application or website name. Router process 352 may be configured to select a runbook included in the one of the entries as the runbook for handling the error. In some embodiments, router process 352 may be configured to look up the one of the runbooks based on the log event message and the payload event message.

Each of runbook A, runbook B, and other runbooks may include one or more steps for handling the error in the synthetic transaction. Event handling process 350 may be configured to execute one or more steps in the one of the runbooks to fix one or more potential issues in service system 100 (FIG. 1B, 1D, 2A) (synthetic monitor flow step 316 in FIG. 3).

An application may include containers that are basic software units and include necessary codes, libraries, and dependencies for operations of the application. The application may also include pods that are smallest deployable units of application software and may include multiple containers that share resources to facilitate efficient communication and resource usage. Nodes and clusters may be collections of physical or virtual machines that run containers and manage their resources to execute the application. The clusters may optimize resource utilization and ensure scalability and high availability across multiple nodes.

In some embodiments, an application software may include a plurality of pods. The runbooks may include a runbook for getting status and an Internet Protocol (IP) address of one of the pods of the application software that encounters the error. For example, event handling process 350 may be configured to execute the runbook to receive status and IP address from the pod that encounters the error. Event handling process 350 may also be configured to execute the runbook to record a cluster name of a machine that runs the pod, a namespace where the pod is located, and/or the pod's name in a memory for a support team.

Alternatively or additionally, in some embodiments, the runbooks may include a runbook for restarting the pod that encounters the error. For example, event handling process 350 may be configured to execute the runbook to delete the existing process of the pod that encounters the error. Event handling process 350 may also be configured to execute the runbook to record a cluster name of a machine that runs the pod, a namespace where the pod is located, and/or the pod's name in the memory for a support team to handle the error manually.

After event handling process 350 executes one or more of the plurality of runbooks to fix one or more potential issues in service system 100, the issues may be removed from service system 100 (FIGS. 1B, 1D, 2A). For example, event handling process 350 may execute a runbook for restarting the pod. After the restarting, service system 100 may not have the one or more issues anymore. Accordingly, by using the synthetic transactions and runbooks, service resilience system 200 may automatically detect and resolve the one or more issues in service system 100. User X and other users may not encounter similar issues anymore. A service provider's service technology team may save its efforts and time for these issues because they have been resolved by service resilience system 200 using synthetic monitors and runbooks. In some embodiments, some of the issues may re-occur occasionally. Service resilience system 200 may be configured to regularly perform synthetic monitors to encounter the occasional issues and clear the issues before users enter them. This may help reduce a chance the user encounters the issues and improve user experience on service system 100 (FIGS. 1B, 1D, and 2A). In some embodiments, some of the issues may occur repeatedly during the execution of the synthetic monitors. Service resilience system 200 may be configured to collect a plurality of log data and provide the log data to the service provider's technology team 106 for analysis.

Alternatively or additionally, in some embodiments, the runbooks may include a runbook for generating a note in a service record of the pod that encounters the error. Service resilience system 200 may be configured to perform the runbook to post a note in the service record of the pod. The note may include at least one of a possible root cause of the error, a link to a knowledge database for dealing with the error, or a plurality of manual runbooks to deal with the error. For example, event handling process 350 may be configured to execute the runbook to post in a note of the pod of synthetic monitor A. The note may include information about a possible root cause of the error, a link to a knowledge database for dealing the error, a plurality of manual runbooks to deal with the error, or any combination thereof in the memory for a support team to handle the error manually. Service resilience system 200 may be configured to post that the possible root cause of the error is that a parameter in service system 100 (FIGS. 1B, 1D, and 2A) is not reset before the pod starts to execute. Service resilience system 200 may also be configured to search the knowledge database for information regarding how to deal with a parameter reset issue, such as adding an instruction to reset the parameter into the pod. In some embodiments, service resilience system 200 may also be configured to identify a plurality of runbooks that are possible solutions or tools to resolve the error or to analyze the error.

Alternatively or additionally, in some embodiments, the runbooks may include a runbook for assigning an incident record of the error as a support task for manual processing. For example, event handling process 350 may be configured to execute the runbook to create an incident for this error and assign the incident as a support task for a supporting team to analyze the error. In some embodiments, the supporting team may correspond to functional information of the runbook. That is, when the runbook is chosen by router process 352, the functional field in the log event message (log event flow step 333) may indicate which one of a plurality of supporting teams is relevant to the error. Alternatively, in some embodiments, the supporting team may not correspond to functional information of the runbook. That is, when router process 352 chooses the runbook, router process 352 may be configured to assign one of the plurality of supporting teams to deal with this error without considering the functional field in the log event message (log event flow step 333).

After event handling process 350 executes some of the plurality of runbooks to generate a note in a service record of the pod or assign an incident record of the error as a support task, the service provider's technology team 106 may have error-relevant information in the note or the incident record. Technology team 106 may be able analyze potential issues that may contribute to the error and develop possible solutions. Accordingly, by using the synthetic transactions and runbooks, service resilience system 200 may automatically detect and collect the error-relevant information for the service provider's technology team 106 to analyze and develop potential solutions. The error-relevant information, including log data may help technology team 106 to resolve the issues faster than traditional methods, where the traditional methods may require technology team 106 to guess potential issues based on the error code of User X's transaction (FIGS. 1A and 1C).

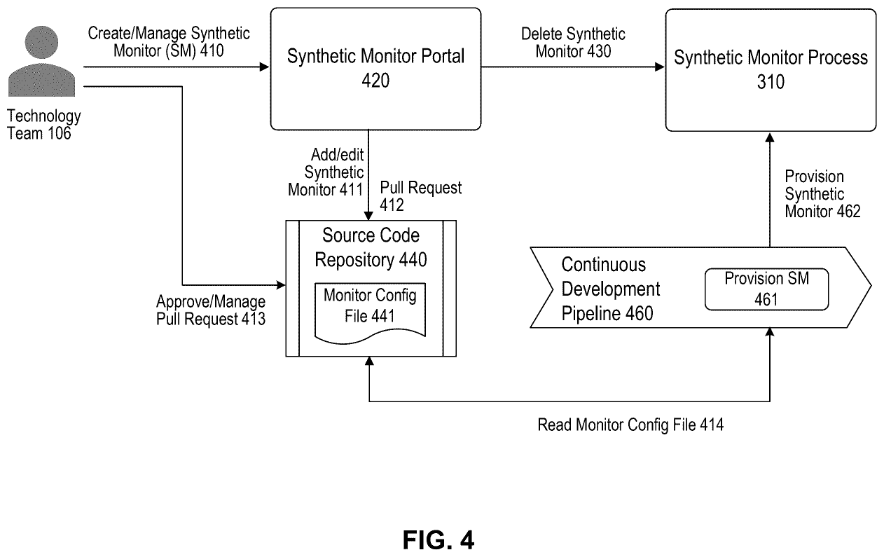

FIG. 4 is a functional diagram showing operation of an exemplary synthetic monitor portal 420, according to some embodiments of the present disclosure. As shown in FIG. 4, synthetic monitor portal 420 may be configured to receive a create or manage synthetic monitor (SM) instruction 410 from technology team 106, such as an instruction to create or manage synthetic monitor A or B (as shown in FIG. 3). After receiving create/manage SM instruction 410 (e.g., an instruction to create a synthetic monitor), synthetic monitor portal 420 may be configured to send an add/edit synthetic monitor instruction 411 to a source code repository 440 for generating a monitor configuration file 441 and store monitor configuration file 441 at source code repository 440. Source code repository 440 may be configured to store source code, including monitor configuration file 441. In some embodiments, synthetic monitor portal 420 may also be configured to send a pull request 412 to source code repository 440. Pull request 412 may involve obtaining and merging new code into the source code in source code repository 440, which may require one or more changes.

Synthetic monitor portal 420 may be configured to operate a continuous development pipeline 460 to generate a provision synthetic monitor 461. In some embodiments, synthetic monitor portal 420 may also be configured to read monitor configuration file 441 to set up provision synthetic monitor 461 (operation 414 in FIG. 4). Synthetic monitor portal 420 may also be configured to set up and add provision synthetic monitor 461 as a synthetic monitor 462 for synthetic monitor process 310 to perform. In some embodiments, synthetic monitor portal 420 may also be configured to create the provision synthetic monitor as a clickpath monitor or a Hypertext Transfer Protocol (HTTP) monitor.

In some embodiments, synthetic monitor portal 420 may be configured to send a delete synthetic monitor instruction 430 to synthetic monitor process 310 to delete a synthetic monitor in synthetic monitor process 310.

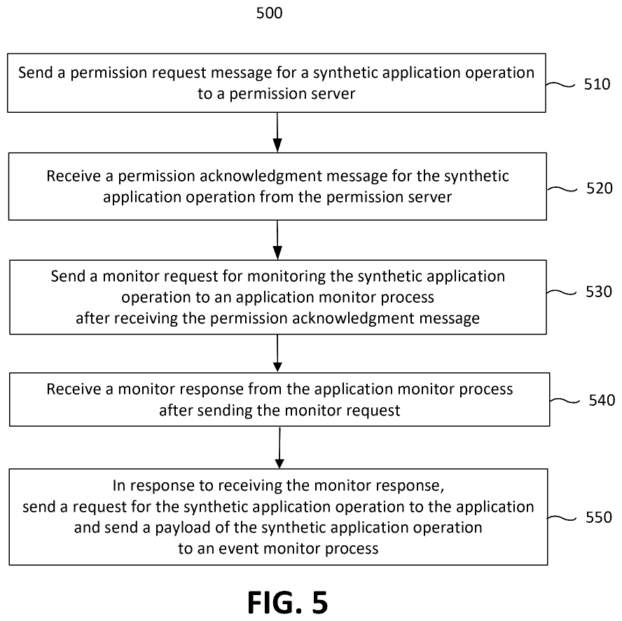

FIG. 5 is a flow chart of an exemplary process 500 for monitoring application operations, according to some embodiments of the present disclosure. Process 500 may include sending a permission request message for a synthetic application operation to a permission server (step 510), receiving a permission acknowledgment message for the synthetic application operation from the permission server (step 520), sending a monitor request for monitoring the synthetic application operation to an application monitor process after receiving the permission acknowledgment message (step 530), receiving a monitor response from the application monitor process after sending the monitor request (540), and in response to receiving the monitor response, sending a request for the synthetic application operation to the application and sending a payload of the synthetic application operation to an event monitor process (step 550).

Step 510 may include sending a permission request message for a synthetic application operation to a permission server. For example, service resilience system 200 may be configured to monitor a synthetic transaction (i.e., a synthetic application operation) on service system 100 in FIG. 1D. The synthetic transaction (e.g., synthetic transaction in FIG. 1D) may be a simulated transaction based on a user transaction (e.g., user transaction in FIG. 1D) initiated by a user on an online service application.

Processor 240 of service resilience system 200 may be configured to execute instructions stored in memory 260 to send an authentication request message (i.e., a permission request message) for the synthetic application operation to permission process 320, i.e., an authentication process executed by a permission server. The permission server may be an authentication server configured to verify whether a synthetic transaction is valid. The authentication request message (i.e., a permission request message) may include information about the synthetic transaction, such as a transaction identification indicating the transaction is a synthetic one, not a user transaction initiated by a service customer. The authentication request message (i.e., a permission request message) may include a request for monitoring execution of the synthetic transaction on the online service application and/or service system 100.

Step 520 may include receiving a permission acknowledgment message for the synthetic application operation from the permission server. For example, processor 240 of service resilience system 200 may be configured to execute instructions stored in memory 260 to receive an authentication approval message (i.e., a permission acknowledgment message) for the synthetic transaction (i.e., the synthetic application operation) from permission process 320 (e.g., an authentication process executed by the permission server). The authentication approval message may include an authorization token (i.e., a permission) for monitoring the execution status of the synthetic transaction at a plurality of API endpoints at the online service application and/or service system 100. An API endpoint may be a digital location (e.g., a uniform resource identifier) where an application programming interface (API) receives requests for data and functionality. In some embodiments, the authorization token may also authorize the synthetic transaction to be performed on service system 100.

Step 530 may include sending a monitor request for monitoring the synthetic application operation to an application monitor process after receiving the permission acknowledgment message. For example, after receiving the authorization approval message from permission process 320, processor 240 of service resilience system 200 may be configured to execute instructions stored in memory 260 to send a monitor request for monitoring the synthetic transaction (i.e., the synthetic application operation) to application monitor process 330 (an application monitor process) at synthetic monitor flow step 312 (FIG. 3).

Step 540 may include receiving a monitor response from the application monitor process after sending the monitor request. For example, processor 240 of service resilience system 200 may be configured to execute instructions stored in memory 260 to receive a monitor response from application monitor process 330 after sending the monitor request. The monitor response may include information confirming that the requested monitoring for the synthetic transaction will be performed.

Step 550 may include in response to receiving the monitor response, sending a request for the synthetic application operation to the application and sending a payload of the synthetic application operation to an event monitor process. For example, processor 240 of service resilience system 200 may be configured to execute instructions stored in memory 260 to send an initiation request to service system 100 for executing the synthetic transaction (e.g., synthetic monitor A in FIG. 3) in response to receiving the monitor response from application monitor process 330. The monitor response may confirm that the requested monitoring for synthetic monitor A will be performed. Processor 240 of service resilience system 200 may be further configured to execute instructions stored in memory 260 to send a payload of the synthetic transaction (e.g., synthetic monitor A) to event monitor process 340, such as synthetic monitor flow step 313 in FIG. 3. The payload of the synthetic transaction may include, for example, a source account, a destination account, an amount of the transaction, and a transaction method (e.g., a wire transfer or an automated clearing house (ACH) transfer).

Some embodiments of process 500 may further include receiving the synthetic application operation from a synthetic monitor portal. For example, processor 240 of service resilience system 200 may be configured to execute instructions stored in memory 260 to receive synthetic monitor B (as shown in FIG. 3) from synthetic monitor portal 420 (as shown in FIG. 4) and store synthetic monitor B in memory 260. Synthetic monitor B may be configured to, for example, monitor a wire transfer on service system 100. Synthetic monitor B may include a synthetic wire transfer. The synthetic wire transfer is similar to a user's wire transfer, except the synthetic wire transfer is allowed to be monitored. Processor 240 may be configured to operate synthetic monitor B to initiate and monitor the synthetic wire transfer on service system 100, similar to operations described above for synthetic monitor A.

Some embodiments of process 500 may further include receiving an error report message and generating the synthetic application operation based on the error report message. The error report message may include an error code of a user application operation performed on the application. For example, processor 240 of service resilience system 200 may be configured to execute instructions stored in memory 260 to receive an error report message from service system 100 (as shown in FIG. 1D). The error report message may include an error code of the user transaction (P1+P2+P3) initiated by user X (as shown in FIG. 1D). Processor 240 may be configured to execute instructions stored in memory 260 to generate the synthetic transaction (P1′+P2′+P3′) based on the error code and/or other information in the error report message.

Some embodiments of process 500 may further include receiving a request for a monitor type. The monitor type may include at least one of a clickpath monitor or an HTTP monitor. For example, processor 240 of service resilience system 200 may be configured to execute instructions stored in memory 260 to receive a request for a monitor type from synthetic monitor portal 420 (as shown in FIG. 4). The monitor type may include a clickpath monitor that records all click operations, or an HTTP monitor that checks the availability of internal resources at a requested HTTP address.

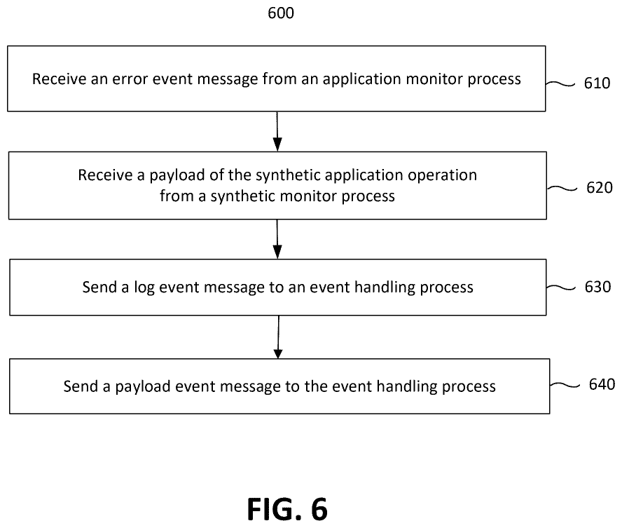

FIG. 6 is a flow chart of an exemplary process 600 for monitoring error events, according to some embodiments of the present disclosure. Process 600 may include receiving an error event message from an application monitor process (step 610), receiving a payload of the synthetic application operation from a synthetic monitor process (step 620), sending a log event message to an event handling process (step 630), and sending a payload event message to the event handling process (step 640).

Step 610 may include receiving an error event message from an application monitor process. For example, processor 240 of service resilience system 200 may be configured to execute instructions stored in memory 260 to perform event monitor process 340 to receive an error event message from application monitor process 330 (or log collector or aggregator 332), as log event flow step 332 described above with reference to FIG. 3. The error event message may include information about an error in procedure P2′ of the synthetic transaction (as shown in FIG. 1D). In some embodiments, the information about the error may include at least one of an error code, an error type, functional information, or an application name.

In some embodiments, an error code in an error event message may correspond to a general error that a plurality of applications and/or APIs may encounter. The error code may correspond to a runbook that could resolve the error in all of the plurality of applications and/or APIs. In some embodiments, an error code in an error event message may correspond to an error that only a corresponding application or API may encounter. The error code may correspond to a runbook that could resolve the error in the corresponding application or API. In some embodiments, an error code in an error event message may correspond to a plurality of applications and/or APIs. The error code may correspond to a runbook that could resolve the error in all of the plurality of applications and/or APIs. In some embodiments, an error code in an error event message may correspond to an application or API. The error code may correspond to a runbook that could resolve the error in the corresponding application or API.

Step 620 may include receiving a payload of the synthetic application operation from a synthetic monitor process. For example, processor 240 of service resilience system 200 may be configured to execute instructions stored in memory 260 to perform event monitor process 340 to receive a payload of the synthetic transaction from synthetic monitor process 310, as described above at synthetic monitor flow step 313 with reference to FIG. 3. The payload of the synthetic transaction may include, for example, a source account, a destination account, an amount of the transaction, and a transaction method (e.g., a wire transfer or an automated clearing house (ACH) transfer).

Step 630 may include sending a log event message to an event handling process. For example, processor 240 of service resilience system 200 may be configured to execute instructions stored in memory 260 to perform event monitor process 340 to send a log event message to event handling process 350, as described above at log event flow step 333 with reference to FIG. 3. The log event message may include the error code, functional information, and/or the application name.

Step 640 may include sending a payload event message to the event handling process. For example, processor 240 of service resilience system 200 may be configured to execute instructions stored in memory 260 to perform event monitor process 340 to send a payload event message to event handling process 350, as described above for synthetic monitor flow step 314 with reference to FIG. 3. The payload event message may include a part or all of the payload of the synthetic transaction, such as the source account, the destination account, the amount of the transaction, and the transaction method (e.g., a wire transfer or an automated clearing house (ACH) transfer).

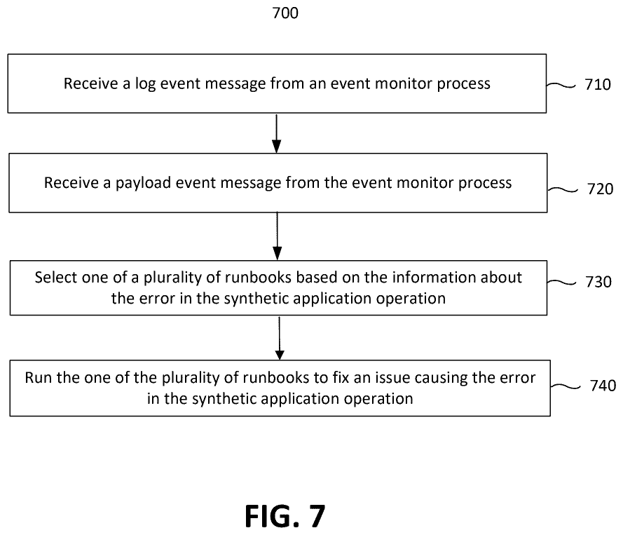

FIG. 7 is a flow chart of an exemplary process 700 for handling an event in application operations, according to some embodiments of the present disclosure. Process 700 may include receiving a log event message from an event monitor process (step 710), receiving a payload event message from the event monitor process (step 720), selecting one of a plurality of runbooks based on the information about the error in the synthetic application operation (step 730), and running the one of the plurality of runbooks to fix an issue causing the error in the synthetic application operation (step 740).

Step 710 may include receiving a log event message from an event monitor process. The log event message may include information about an error in a synthetic application operation on an application. For example, processor 240 of service resilience system 200 may be configured to execute instructions stored in memory 260 to perform event handling process 350 to receive the log event message from event monitor process 340, as described above at log event flow step 333 with reference to FIG. 3. The log event message may include at least one of the error code, functional information, or the application name.

Step 720 may include receiving a payload event message from the event monitor process. For example, processor 240 of service resilience system 200 may be configured to execute instructions stored in memory 260 to perform event handling process 350 to receive the payload event message from event monitor process 340, as described above at synthetic monitor flow step 314 with reference to FIG. 3. The payload event message may include a part or all of the payload of the synthetic transaction, such as the source account, the destination account, the amount of the transaction, and the transaction method (e.g., a wire transfer or an automated clearing house (ACH) transfer).

Step 730 may include selecting one of a plurality of runbooks based on the information about the error in the synthetic application operation. The one of the plurality of runbooks may include one or more steps for handling the error in the synthetic application operation. For example, processor 240 of service resilience system 200 may be configured to execute instructions stored in memory 260 to perform event handling process 350 to look up the catalog application programming interfaces (APIs) 360 based on the log event message to select runbook A (as synthetic monitor flow step 315 shown in FIG. 3) for handling the error. Specifically, processor 240 may be configured to run router process 352 to compare the error code, the functional information, and/or the application name in the log event message with those in entries of the catalog APIs 360 and select an entry of the catalog APIs 360 having the same error code, the functional information, and/or the application name, for fixing a potential issue on service system 100.

In some embodiments, processor 240 may be configured to execute instructions stored in memory 260 to run router process 352 to compare the error code, the functional information, and the application name in the log event message with those in entries of the catalog APIs 360 and select an entry of the catalog APIs 360 having the same error code, the functional information, and the application.

In some embodiments, processor 240 may be configured to execute instructions stored in memory 260 to run router process 352 to select the runbook A among a plurality of runbooks based on the information about the error in the synthetic transaction and the payload of the synthetic transaction. The information about the error may include at least one of an error code, an error type, functional information, or an application name. The payload of the synthetic transaction may include the source account, the destination account, the amount of the transaction, and the transaction method (e.g., a wire transfer or an automated clearing house (ACH) transfer).

In some embodiments, an error code may correspond to a general error that a plurality of applications and/or APIs may encounter. The error code may correspond to a runbook that could resolve the error in all of the plurality of applications and/or APIs. Processor 240 may be configured to execute instructions stored in memory 260 to run router process 352 to select the runbook for resolving the error in one of the plurality of applications and/or APIs. In some embodiments, an error code may correspond to an error that only a corresponding application or API may encounter. The error code may correspond to a runbook that could resolve the error in the corresponding application or API. Processor 240 may be configured to execute instructions stored in memory 260 to run router process 352 to select the runbook for resolving the error in the corresponding application or API.

In some embodiments, an error code may correspond to a plurality of applications and/or APIs. The error code may correspond to a runbook that could resolve the error in all of the plurality of applications and/or APIs. Processor 240 may be configured to execute instructions stored in memory 260 to run router process 352 to select the runbook for resolving the error in one of the plurality of applications and/or APIs. In some embodiments, an error code may correspond to an application or API. The error code may correspond to a runbook that could resolve the error in the corresponding application or API. Processor 240 may be configured to execute instructions stored in memory 260 to run router process 352 to select the runbook for resolving the error in the corresponding application or API.

Step 740 may include running the one of the plurality of runbooks to fix an issue causing the error in the synthetic application operation. For example, processor 240 of service resilience system 200 may be configured to execute instructions stored in memory 260 to perform event handling process 350 to run one or more steps in runbook A to fix an issue causing the error in procedure P2′ (as shown in FIG. 1D) of the synthetic transaction (i.e., synthetic monitor flow step 316 in FIG. 3). For example, the one or more steps may include resetting a database that causes procedure P2′ to stop.

Some embodiments of process 700 may further include running the one of the plurality of runbooks to fix the issue based on the payload of the synthetic application operation. For example, processor 240 of service resilience system 200 may be configured to execute instructions stored in memory 260 to perform event handling process 350 to run runbook A to fix a potential issue based on the payload of the synthetic transaction, including the source account, the destination account, the amount of the transaction, and the transaction method (e.g., a wire transfer or an automated clearing house (ACH) transfer). Specifically, processor 240 may be configured to run runbook A to reset a database of destination accounts. The reset database of destination accounts may be recovered to be able to provide correct information about the destination account in the synthetic transaction. Based on the correct information about the destination account, service system 100 may be able to perform the synthetic transaction (P1′+P2′+P3′) and the user transaction (P1+P2+P3).

In some embodiments, processor 240 of service resilience system 200 may be configured to execute instructions stored in memory 260 to perform event handling process 350 to run one or more of a first runbook for getting status and an Internet Protocol (IP) address of a pod that encounters the error, a second runbook for restarting the pod that encounters the error, a third runbook for generating a note in a service record of the pod that encounters the error, a fourth runbook for assigning an incident record of the error as a support task for manual processing, or any combination thereof, as described above with reference to FIG. 3. The generating operation may be a form of posting.

The systems and methods for monitoring synthetic application operations and handling application operation errors by runbooks may enhance service system 100 to provide a variety of services to users. When an error occurs in a user transaction or a requested service, the systems and methods may be configured to identify potential issues by synthetic transactions or application operations and resolve the issues by a plurality of runbooks. These systems and methods may improve the robustness of service system 100 or other service providing systems, save user time, and improve efficiency of technology teams of service providers.

Another aspect of the disclosure is directed to a non-transitory computer-readable medium storing instructions which, when executed, cause one or more computers to perform the methods discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be appreciated that the present disclosure is not limited to the exact construction that has been described above and illustrated in the accompanying drawings, and that various modifications and changes can be made without departing from the scope thereof. It is intended that the scope of the application should only be limited by the appended claims.

1-4. (canceled)

5. A system for monitoring error events, the system comprising:
a memory storing instructions; and
at least one processor coupled to the memory, the at least one processor configured to execute the instructions to:
receive an error event message from an application monitor process, the error event message including information about an error in a synthetic application operation on an application, wherein the application is configured for performing application operations;
receive a payload of the synthetic application operation from a synthetic monitor process;
send a log event message to an event handling process, the log event message including the information about the error; and
send a payload event message to the event handling process, the payload event message including the payload of the synthetic application operation.

6. The system of claim 5, wherein the information about the error includes at least one of an error code, an error type, functional information, or an application name.

7-16. (canceled)

17. A method for monitoring error events, the method comprising:
receiving an error event message from an application monitor process, the error event message including information about an error in a synthetic application operation on an application, wherein the application is configured for performing application operations;
receiving a payload of the synthetic application operation from a synthetic monitor process;
sending a log event message to an event handling process, the log event message including the information about the error; and
sending a payload event message to the event handling process, the payload event message including the payload of the synthetic application operation.

18. The method of claim 17, wherein the information about the error includes at least one of an error code, an error type, functional information, or an application name.

19-25. (canceled)

26. A non-transitory computer-readable medium storing instructions which, when executed, cause at least one processor to perform operations for monitoring error events, the operations comprising:
receiving an error event message from an application monitor process, the error event message including information about an error in a synthetic application operation on an application, wherein the application is configured for performing application operations;
receiving a payload of the synthetic application operation from a synthetic monitor process;
sending a log event message to an event handling process, the log event message including the information about the error; and
sending a payload event message to the event handling process, the payload event message including the payload of the synthetic application operation.

27. (canceled)

28. The non-transitory computer-readable medium of claim 26, wherein the information about the error includes at least one of: an error code, an error type, functional information, or an application name.

29. The non-transitory computer-readable medium of claim 26, wherein the synthetic application operation includes a simulated operation based on a user application operation performed on the application.

30. The non-transitory computer-readable medium of claim 29, wherein:
the synthetic application operation is generated based on an error report message; and
the error report message includes an error code corresponding to the user application operation.

31. The non-transitory computer-readable medium of claim 29, wherein the synthetic application operation is monitored on the application.

32. The non-transitory computer-readable medium of claim 31, wherein log data collected during execution of the synthetic application operation is more than log data collected during execution of the user application operation on the application.

33. The non-transitory computer-readable medium of claim 32, wherein the log data of the synthetic application operation is collected when execution time of the synthetic application operation is longer than a threshold.

34. The system of claim 5, wherein the synthetic application operation includes a simulated operation based on a user application operation performed on the application.

35. The system of claim 34, wherein:
the synthetic application operation is generated based on an error report message, and
the error report message includes an error code corresponding to the user application operation.

36. The system of claim 34, wherein the synthetic application operation is monitored on the application.

37. The system of claim 34, wherein log data collected during execution of the synthetic application operation is more than log data collected during execution of the user application operation on the application.

38. system of claim 37, wherein the log data of the synthetic application operation is collected when execution time of the synthetic application operation is longer than a threshold.

39. The method of claim 17, wherein the synthetic application operation includes a simulated operation based on a user application operation performed on the application.

40. The method of claim 39, wherein:
the synthetic application operation is generated based on an error report message, and
the error report message includes an error code corresponding to the user application operation.

41. The method of claim 39, wherein the synthetic application operation is monitored on the application.

42. The method of claim 39, wherein log data collected during execution of the synthetic application operation is more than log data collected during execution of the user application operation on the application.
